(19) United States
(12) Patent Application Publication
(10) Pub. No.: US 2013/0170651 A1
(43) Pub. Date: Jul. 4, 2013

(54) APPARATUS AND METHOD FOR EDITING MULTICHANNEL AUDIO SIGNAL

(71) Applicant: Electronics and Telecommunications Research Institute, Daejeon (KR)

(72) Inventors: Yong Ju LEE, Daejeon (KR); Jeong Il SEO, Daejeon (KR); Keun Woo CHOI, Seoul (KR); Kyeong Ok KANG, Daejeon (KR)

(73) Assignee: Electronics and Telecommunications Research Institute, Daejeon (KR)

(21) Appl. No.: 13/733,617

(22) Filed: Jan. 3, 2013

(30) Foreign Application Priority Data
Jan. 4, 2012 (KR) 10-2012-0001170

(51) Int. Cl. H04R 3/12

(52) U.S. Cl. CPC H04R 3/12
USPC 381/20

(57) ABSTRACT

An apparatus and method for generating a multichannel audio signal showing a 3-dimensional (3D) effect by editing an existing multichannel audio signal. The apparatus may include an output location determiner to determine location to output an object audio signal using editing information of the object audio signal, and a multichannel object audio signal generator to generate a multichannel object audio signal by allocating the object audio signal to channels corresponding to the location to output the object audio signal.

### CROSS-REFERENCE TO RELATED APPLICATION

This application claims the benefit of Korean Patent Application No. 10-2012-0001170, filed on Jan. 4, 2012, in the Korean Intellectual Property Office, the disclosure of which is incorporated herein by reference.

### BACKGROUND

1. Field of the Invention

The present invention relates to an apparatus and method for emitting a multichannel audio signal, and more particularly, to a multichannel audio signal editing apparatus and method that generates a multichannel audio signal showing a 3-dimensional (3D) effect by editing an existing multichannel audio signal.

2. Description of the Related Art

With an increase in multimedia content quality, multichannel audio content that uses more channels than 5.1-channel audio content is being produced.

An audio editing apparatus according to a related art is adapted to only edit stereo audio or 5.1-channel audio. Therefore, an audio engineer used to manually perform most of editing functions such as channel mixing, sound volume control, and the like.

However, when the number of audio channels exceeds the 5.1-channel, it becomes hard for the audio engineer to manually control the editing functions for all the channels.

In addition, since the related-art audio editing apparatus performs editing manually according to the number of channels, location of a speaker in use, and preset audio reproduction environments, when the reproduction environments are changed, re-edition may be necessary according to the changed reproduction environments.

Accordingly, there is a demand for a multichannel audio editing method improved to edit multichannel audio automatically and omit re-edition even when channel environments are changed.

### SUMMARY

An aspect of the present invention provides an apparatus and method for generating a multichannel audio signal showing a 3-dimensional (3D) effect.

Another aspect of the present invention provides an apparatus and method for obtaining a second multichannel audio signal edited according to a user intention, without having to use another method for editing the second multichannel audio signal.

According to an aspect of the present invention, there is provided a multichannel audio signal editing apparatus including an output location determiner to determine location to output an object audio signal using editing information of the object audio signal, and a multichannel object audio signal generator to generate a multichannel object audio signal by allocating the object audio signal to channels corresponding to the location to output the object audio signal.

The multichannel audio signal editing apparatus may further include a multichannel audio signal converter to convert a first multichannel audio signal to a second multichannel audio signal that corresponds to the multichannel object audio signal, and an audio mixer to generate a third multichannel audio signal by mixing the multichannel object audio signal with the second multichannel audio signal.

The multichannel audio signal converter may edit at least one of channels of the first multichannel audio signal according to an editing command received from a user, and convert the first multichannel audio signal including the edited channel into the second multichannel audio signal corresponding to the multichannel object audio signal.

According to another aspect of the present invention, there is provided a multichannel audio signal editing method including determining location to output an object audio signal using editing information of the object audio signal, and generating a multichannel object audio signal by allocating the object audio signal to audio channels corresponding to the location to output the object audio signal.

### EFFECT

According to embodiments of the present invention, a multichannel audio signal showing a 3-dimensional (3D) effect may be generated by generating a new multichannel audio signal according to location of a 3D sound source and mixing the new multichannel audio signal with an existing multichannel audio signal.

Additionally, according to embodiments of the present invention, a channel of a first multichannel audio signal is edited by a conventional editing method and then converted into a second multichannel audio signal. Therefore, an edited second multichannel audio signal may be obtained as desired by a user without another method for editing the second multichannel audio signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a multichannel audio signal editing apparatus according to an embodiment of the present invention;

FIG. 2 is a diagram illustrating an example of a multichannel object audio signal generated by a multichannel object audio signal generator according to a movement of an object, according to an embodiment of the present invention;

FIG. 3 is a diagram illustrating another example of a multichannel object audio signal generated by a multichannel object audio signal generator according to an embodiment of the present invention; and

FIG. 4 is a flowchart illustrating a multichannel audio signal editing method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A multichannel audio signal editing method according to an embodiment of the present invention may be performed by a multichannel audio signal editing apparatus.

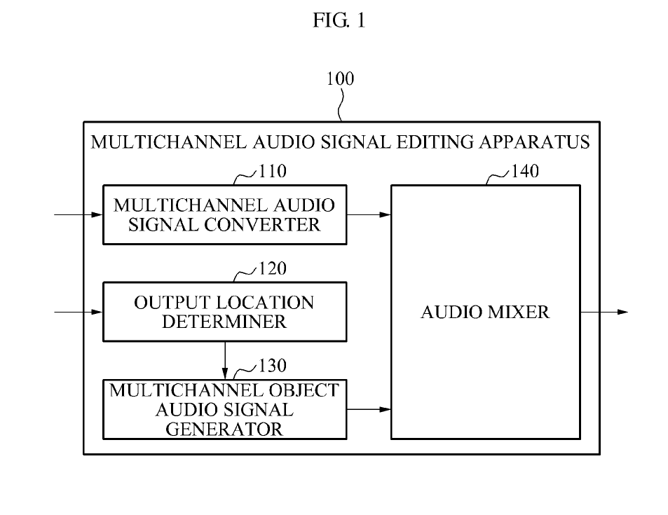

FIG. 1 is a block diagram illustrating a multichannel audio signal editing apparatus 100 according to an embodiment of the present invention.

Referring to FIG. 1, the multichannel audio signal editing apparatus 100 may include a multichannel audio signal converter 110, an output location determiner 120, a multichannel object audio signal generator 130, and an audio mixer 140.

The multichannel audio signal converter 110 may convert a first multichannel audio signal into a second multichannel audio signal. The first multichannel audio signal may refer to an existing multichannel audio signal such as a 5.1-channel audio signal. The second multichannel audio signal may refer to a new audio signal such as a 7.1-channel, 10.2-channel, 13.2-channel, and 22.2-channel signal. In addition, the first multichannel audio signal may be an audio signal received simply according to channels.

That is, the multichannel audio signal converter 110 may convert an existing multichannel audio signal to one of recent multichannel audio signals according to a user request.

Additionally, the multichannel audio signal converter 110 may edit at least one of channels of the first multichannel audio signal according to an editing command received from a user. The multichannel audio signal converter 110 may convert the first multichannel audio signal including the edited channel into the second multichannel audio signal corresponding to the multichannel object audio signal.

That is, the multichannel audio signal converter 110 may edit the channel of the first multichannel audio signal by a conventional editing method, and convert the first multichannel audio signal including the edited channel into the second multichannel audio signal corresponding to the multichannel object audio signal, thereby obtaining the second multichannel audio signal edited according to intention of the user.

The output location determiner 120 may determine location to output an object audio signal using editing information of the object audio signal. In addition, the output location determiner 120 may determine an output level of the object audio signal.

Here, the object may include a structure that generates a 3-dimensional (3D) sound source. The object multichannel audio signal may include an audio signal of the 3D sound source corresponding to the object, a stereo signal, or a mono audio signal. For example, the object may include an object that generates a sound such as a train or an animal, and a natural phenomenon such as a lightning. The object audio signal may include a sound generated from the corresponding object, such as a train sound, an animal crying.

The editing information of the object audio signal may include information related to a direction and distance of the object corresponding to the object audio signal. For example, when the object audio signal is the animal crying, the editing information of the object audio signal may be information related to a direction and distance of a corresponding animal.

In detail, the output location determiner 120 may determine a speaker that outputs the object audio signal and the output level of the audio signal, so that the object audio signal is output in a direction from the object using direction information of the editing information of the object audio signal. In this instance, when the object moves, the output location determiner 120 may change a speaker to output the object audio signal according to a moved place of the object, so that the user listening to the object audio signal may sense the object moving.

Furthermore, the output location determiner 120 may determine the output level of the object audio signal to be output from the speaker, using distance information of the editing information of the object audio signal. For example, when the object is located nearby, the output location determiner 120 may increase the output level of the object audio signal to be output from the speaker. Also, when the object is located far, the output location determiner 120 may decrease the output level of the object audio signal to be output from the speaker. Accordingly, the user listening to the object audio signal may sense the movement of the object.

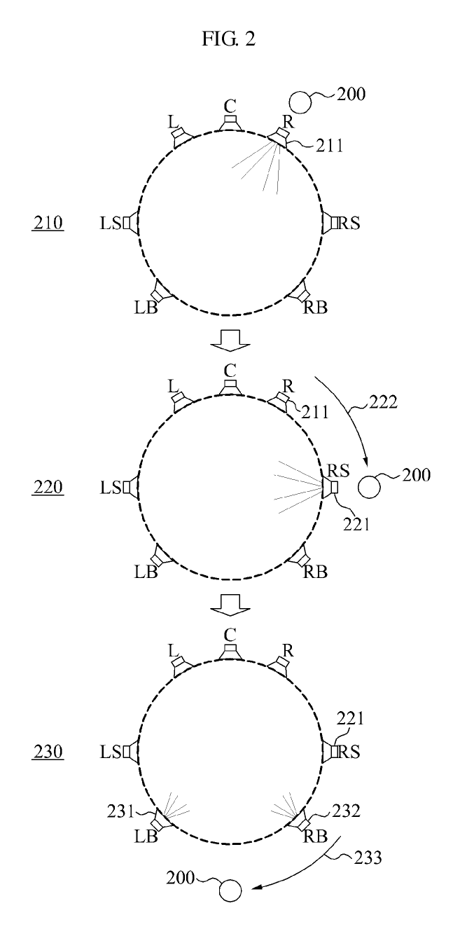

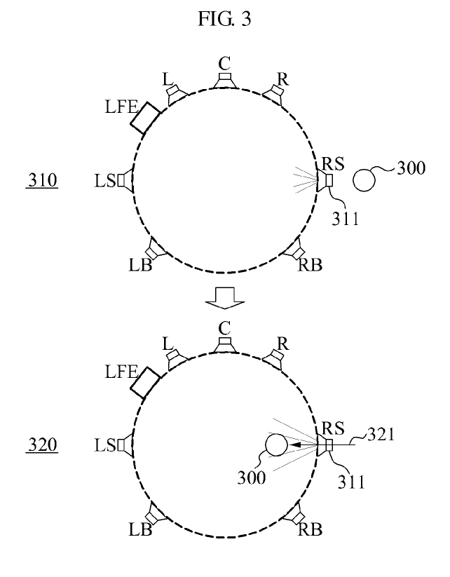

Characteristics of the object audio signal and the output location will be described in detail later with reference to FIGS. 2 and 3.

The multichannel object audio signal generator 130 may allocate the object audio signal to channels corresponding to the location to output the object audio signal, thereby generating a multichannel object audio signal.

In detail, the multichannel object audio signal generator 130 may allocate the object audio signal to the channel determined by the output location determiner 120 among channels corresponding to output channel information, thereby generating the multichannel object audio signal. Here, the output channel information may include a number of channels of the multichannel object audio signal and location information of the speaker that outputs the respective channels. The number of channels of the multichannel object audio signal may be equal to a number of channels of the second multichannel audio signal converted by the multichannel audio signal converter 110.

The multichannel object audio signal generator 130 may set the output level of the object audio signal which is allocated according to the output level determined by the output location determiner 120.

That is, since the multichannel object audio signal generator 130 generates the multichannel object audio signal so that the audio signal is output depending on the location of the object, the user listening to the multichannel object audio signal may sense the location, the movement, and the moving direction of the object.

The audio mixer 140 may mix the multichannel object audio signal with the second multichannel audio signal, thereby generating a third multichannel audio signal. The third multichannel audio signal may be an output multichannel audio signal output to the user.

That is, the audio mixer 140 may add a sound source corresponding to the object to content corresponding to the multichannel audio signal, by mixing the multichannel object audio signal with the second multichannel audio signal converted from the first multichannel audio signal, that is, the existing signal. For example, when a movie including a multichannel audio signal includes a scene in which an animal moves around a main character, a multichannel object audio signal denoting location of the animal may be added to a multichannel audio signal denoting a background sound source of the scene. Therefore, the user may sense the animal moving while listening to the background sound source simultaneously.

In addition, the audio mixer 140 may generate and store multichannel editing information that includes at least one of channel information of the third multichannel audio signal, the editing information of the object audio signal, channel information of the second multichannel audio signal, and mixing information.

FIG. 2 is a diagram illustrating an example of a multichannel object audio signal generated by a multichannel object audio signal generator 130 according to a movement of an object, according to an embodiment of the present invention.

That is, FIG. 2 shows an example multichannel object audio signal generated by the multichannel object audio signal generator 130 when an object 200 moves to the right with respect to a user.

First, when an output location determiner 120 determines a speaker 211 to output the multichannel audio signal according to location of the object 200, the multichannel object audio signal generator 130 may generate a multichannel object audio signal 210 by allocating an object audio signal to a channel R corresponding to the speaker 211.

Next, when the object 200 is moved to the right as indicated by an arrow 221, the output location determiner 120 may determine a speaker 222 to output the object audio signal according to the location of the object 200. Here, the multichannel object audio signal generator 130 may allocate the object audio signal to a channel RS corresponding to the speaker 222, and generate a multichannel object signal 220 preventing the object audio signal from being reproduced in the channel R. Since the object audio signal that has been reproduced through the speaker 211 is now reproduced through the speaker 222, the user may sense that the object 200 has moved to the right.

In addition, when the object 200 is moved to a rear as indicated by an arrow 231, the output location determiner 120 may determine a speaker to output the object audio signal according to the location of the object 200. Here, when a speaker corresponding to the location of the object 200 is absent, the output location determiner 120 may determine speakers 232 and 233 nearest to the location of the object 200 as the speaker to output the object audio signal. When a plurality of the speakers 232 and 233 are determined as the speaker to output the object audio signal, the output location determiner 120 may control magnitudes of object audio signals to be output through the respective speakers 232 and 233 depending on distances between the speakers 232 and 233 and the object 200, so that the user may sense the location of the object 200.

Here, the multichannel object audio signal generator 130 may allocate the object audio signal to a channel LB and a channel RB corresponding to the speakers 232 and 233, respectively, and generate a multichannel object audio signal 230 preventing the object audio signal generated in the channel RS.

FIG. 3 is a diagram illustrating another example of a multichannel object audio signal generated by a multichannel object audio signal generator 130 according to an embodiment of the present invention.

That is, FIG. 3 shows an example of the multichannel object audio signal generated by the multichannel object audio signal generator 130 of when an object 300 approaches the user.

First, when the output location determiner 120 determines a speaker 311 to output the object audio signal according to location of the object 300, the multichannel object audio signal generator 130 may generate a multichannel object audio signal 310 by allocating an object audio signal to a channel RS corresponding to the speaker 311.

Here, when the object 300 approaches the user as indicated by an arrow 321, the output location determiner 120 may determine a magnitude of the object audio signal to be output through the speaker 311 according to the location of the object 300. That is, the output location determiner 120 may increase the output level of the object audio signal to be output through the speaker 300 since a distance between the user and the object 300 is reduced.

In this instance, the multichannel object audio signal generator 130 may generate a multichannel object audio signal 320 by increasing the magnitude of the object audio signal allocated to the channel RS. Here, the user may sense the object 300 approaching since the magnitude of the object audio signal being reproduced through the speaker 311 is increased.

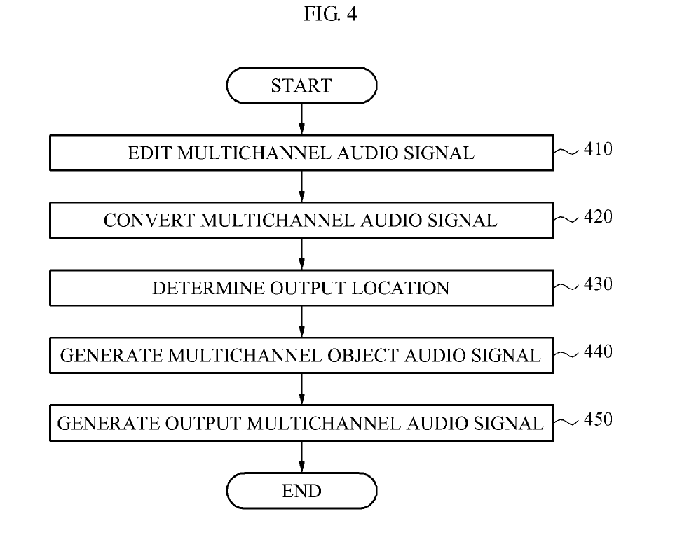

FIG. 4 is a flowchart illustrating a multichannel audio signal editing method according to an embodiment of the present invention.

In operation 410, a multichannel audio signal converter 110 may edit at least one of channels of a first multichannel audio signal according to an editing command received from a user.

In operation 420, the multichannel audio signal converter 110 may convert the first multichannel audio signal including the channel edited in operation 410, into a second multichannel audio signal corresponding to the multichannel object audio signal.

In operation 430, the output location determiner 120 may determine location to output the object audio signal using the editing information of the object audio signal. The output location determiner 120 may also determine an output level of the object audio signal.

In operation 440, the multichannel object audio signal generator 130 may allocate the object audio signal to channels corresponding to the location determined in operation 430, thereby generating a multichannel object audio signal.

In operation 450, the audio mixer 140 may mix the multichannel object audio signal generated in operation 440 with the second multichannel audio signal converted in operation 420, thereby generating a third multichannel audio signal. The third multichannel audio signal may be an output multichannel audio signal output to the user.

According to the embodiments, a new multichannel audio signal is generated according to location of a 3D sound source and mixed with an existing multichannel audio signal. As a result, a multichannel audio signal showing the 3D effect may be generated.

In addition, a channel of a first multichannel audio signal is edited by a conventional editing method, and the edited first multichannel audio signal is converted into a second multichannel audio signal. Therefore, the second multichannel audio signal edited according to an intention of the user may be obtained without another method for editing the second multichannel audio signal.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for editing a multichannel audio signal, the apparatus comprising:
an output location determiner to determine location to output an object audio signal using editing information of the object audio signal; and
a multichannel object audio signal generator to generate a multichannel object audio signal by allocating the object audio signal to audio channels corresponding to the location to output the object audio signal.

2. The apparatus of claim 1, further comprising:
a multichannel audio signal converter to convert a first multichannel audio signal to a second multichannel audio signal that corresponds to the multichannel object audio signal; and
an audio mixer to generate a third multichannel audio signal by mixing the multichannel object audio signal with the second multichannel audio signal.

3. The apparatus of claim 2, wherein the audio mixer generates multichannel editing information comprising at least one of channel information of the third multichannel audio signal, the editing information of the object audio signal, channel information of the second multichannel audio signal, and mixing information.

4. The apparatus of claim 2, wherein the multichannel audio signal converter edits at least one of channels of the first multichannel audio signal according to an editing command received from a user, and converts the first multichannel audio signal including the edited channel into the second multichannel audio signal corresponding to the multichannel object audio signal.

5. The apparatus of claim 1, wherein the object audio signal comprises an audio signal of a 3-dimensional (3D) sound source corresponding to the object.

6. The apparatus of claim 1, wherein the object audio signal editing information comprises information related to a direction and distance of an object corresponding to the object audio signal.

7. A method for editing a multichannel audio signal, the method comprising:
determining location to output an object audio signal using editing information of the object audio signal; and
generating a multichannel object audio signal by allocating the object audio signal to audio channels corresponding to the location to output the object audio signal.

8. The method of claim 7, further comprising:
converting a first multichannel audio signal to a second multichannel audio signal that corresponds to the multichannel object audio signal; and
generating a third multichannel audio signal by mixing the multichannel object audio signal with the second multichannel audio signal.

9. The method of claim 8, wherein the generating of the third multichannel audio signal generates multichannel editing information comprising at least one of channel information of the third multichannel audio signal, the editing information of the object audio signal, channel information of the second multichannel audio signal, and mixing information.

10. The method of claim 8, wherein the converting into the second multichannel audio signal comprises:
editing at least one of channels of the first multichannel audio signal according to an editing command received from a user; and
converting the first multichannel audio signal including the edited channel into the second multichannel audio signal corresponding to the multichannel object audio signal.

11. The method of claim 7, wherein the object audio signal comprises an audio signal of a 3-dimensional (3D) sound source corresponding to the object.

12. The method of claim 7, wherein the editing information of the object audio signal comprises information related to a direction and distance of an object corresponding to the object audio signal.
